(19) United States
(12) Patent Application Publication
(10) Pub. No.: US 2003/0048271 A1
(43) Pub. Date: Mar. 13, 2003

(54) Image device having camera and image perspective correction and possibly rotation and staggering correction

(76) Inventors: Martin Dieter Liess, Eindhoven (NL); Gillian Antoinette Mimnagh-Kelleher, Eindhoven (NL)

Correspondence Address: Michael E. Marion, c/o U.S. PHILIPS CORPORATION, Intellectual Property Department, 580 White Plains Road, Tarrytown, NY, 10591, US

(21) Appl. No.: 10/236,182

(22) Filed: Sep. 6, 2002

(30) Foreign Application Priority Data
Sep. 7, 2001 (EP) 01203382.5

(51) Int. Cl. G06T 17/00

(52) U.S. Cl. 345/428; 358/1.2

(57) ABSTRACT

An image device (1), comprises image means (2) for taking an initial image (I) including graphics and/or text, and an image correcting means (4) coupled to the image means (2) for correcting the image taken. The image means (2) are camera means (2), and the image correcting means (4) are arranged for performing perspective corrections by effecting image sizing on the image taken. This way perspective errors emanating from the taking of a flat image can be corrected for by means of appropriate software. Implementation of the feature in for example a mobile GSM telephone already including a microprocessor is therefore advantageous allowing high quality fax communication.

The present invention relates to an image device, comprising image means for taking an initial image including graphics and/or text, and an image correcting means coupled to the image means for correcting the image taken.

The present invention also relates to a data processing device such as an organizer or a communication device, for example a telephone, in particular a mobile telephone, which data processing device is provided with such an image device, a method for processing the image taken and an image processed according to said method.

Such an image device is known from the Japanese patent publication No. 10289302 A. The known image device comprises image means in the form of image scanning means for taking an image by scanning it, whereby the scanned image comprises a density distorted part. Such a density distorted part emanates from the fact that scanned image is not flat, which may arise for example when a book is scanned and the center line section of the book, which is being scanned is curved in the third dimension. The scanned image may then be subjected to a density distortion correction by enlarging pixels of data of the scanned image in both a horizontal and vertical scanning direction with appropriately determined scale factors. In order to determine those scale factors edge positions of both the original image and the scanned image are being detected.

Such an enlarging pixel correction is however not suited if an image of a flat area is taken and if a high quality fax image is required.

Therefore it is an object of the present invention to provide a cost effective and low power consuming image device and method, capable of reconstructing a virtually distortion free high quality fax image taken from a flat original image with image processing, which allows the image taken to be fax encoded.

Thereto the image device according to the invention is characterized in that the image means are camera means, and that the image correcting means are arranged for performing perspective corrections by effecting image sizing on the image taken.

It is an advantage of the image device according to the present invention that relatively cheap and small camera means, such as a digital camera or line scan camera can be used, whose output digital image data may be easily corrected as to the perspective of the image taken, due to the fact that the original image was flat. Advantageously no density distortion arises and consequently no density distortion correction will be needed when camera means are used.

The perspective corrections which may arise are associated with the fact that the camera means may not be hold precisely centrally and perpendicularly over all parts of the image to be taken or to be scanned. As a consequence of the substantially flat original image the associated perspective image correction concerns the sizing of the image taken. Therefore the processing by the image correcting means is rather straightforward and may even be effected by a low power consuming common microprocessor, such as a microprocessor already available in marketed data processing or communication devices, in particular mobile telephones. The implementation of the image device in present days communication devices, such as in particular GSM telephones, is now possible and significantly increases useful application possibilities thereof, without substantially violating its sizes or the life time of a power supply, usually including common rechargeable batteries.

One embodiment of the image device according to the invention is characterized in that the image correcting means are additionally arranged for performing rotation and/or staggering corrections.

The rotation correction is associated with the fact that the camera means may not be hold precisely in a way that the edges of the image taken are parallel to the edges of the original image, whereas the staggering correction is associated with the fact that the camera means may be moved or shaken slightly during the taking of the image. At least one of both corrections can advantageously be carried out.

One other embodiment of the image device according to the invention is characterized in that the image correcting means are arranged as alignment means for effecting edge alignment along respective left and/or right edges of the image taken.

Advantageously a choice can be made between edge alignment to the left alone, to the right alone, or partly to the left and partly to the right or vice versa.

A further embodiment of the image device according to the invention is characterized in that the image correcting means are arranged as image contracting and/or image stretching means, in particular image line and/or image column contracting and stretching means respectively.

The image contraction will be applied by the image contracting means if camera means are used which have a higher resolution as the resolution of the image taken. By applying image stretching additional points or pixels can be inserted into the image or scan lines to be stretched -preferably at equal distances- which have a color or gray value which is the average of the color of neighboring pixels. If only stretching is performed no image resolution gets lost during any image processing step. Therefore this method is preferred in case of a relatively low resolving camera means, which then results in a maximum quality of the processed image. The image taken and processed may thereafter be fax encoded and transmitted to another similarly arranged device.

Accordingly the method for processing an image taken comprising image lines and image columns, according to the present invention, is characterized by one or more of the following steps:

aligning the image lines;

sizing the image lines;

aligning the image columns;

sizing the image columns;

sizing the image lines and image columns to form a desired processed image format.

Advantageously the order of first treating the image lines and then the image columns may according to the invention be reversed, if desired. In particular the sizing concerns a stretching and/or a contraction, as elucidated above.

A further detailed embodiment of the method according to the invention is characterized in that the amount of stretching of the image lines and/or image columns is a linear function of the length and position of a first and a last complete image line and/or image column respectively.

Advantageously this results in an effective filling out of image space available.

At present the image device and associated method according to the invention will be elucidated further together with their additional advantages, while reference is being made to the appended drawing.

In the drawing:

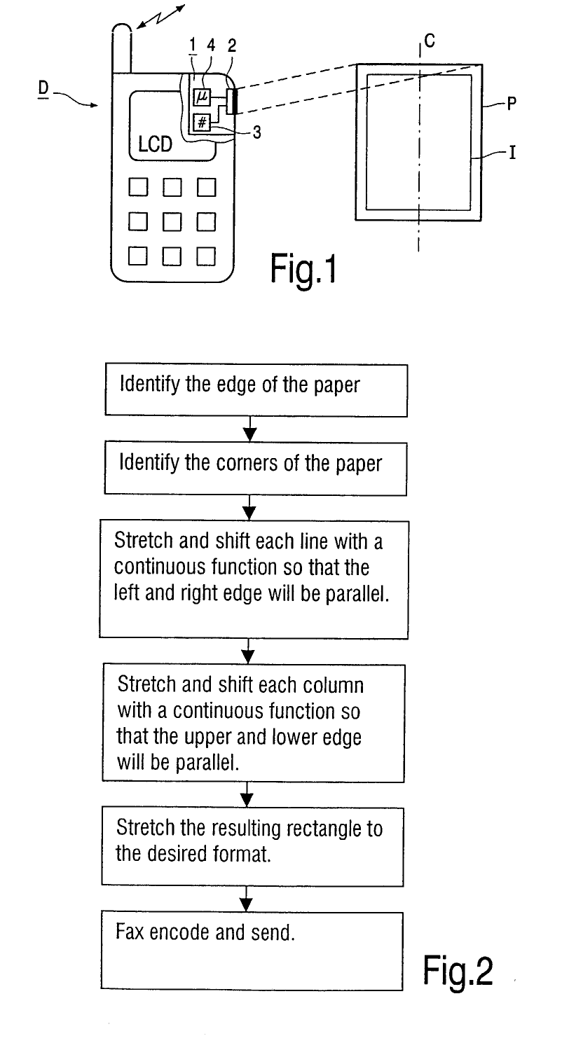

FIG. 1 shows a general outline of a possible embodiment of the image device according to the invention as included in a mobile data processing device;

FIG. 2 shows a principle algorithm of the method according to the invention for correcting perspective errors and possibly additional errors in an image taken by the image device of FIG. 1;

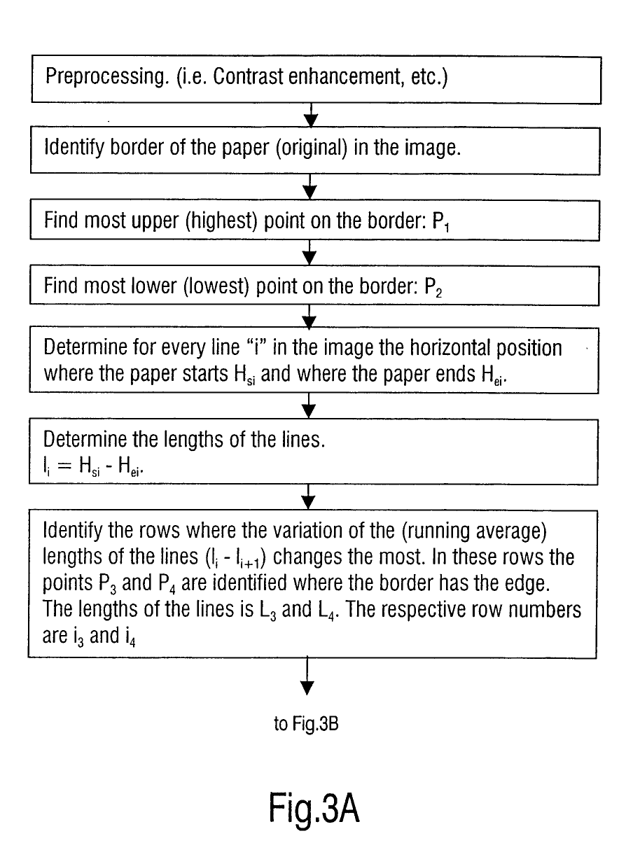

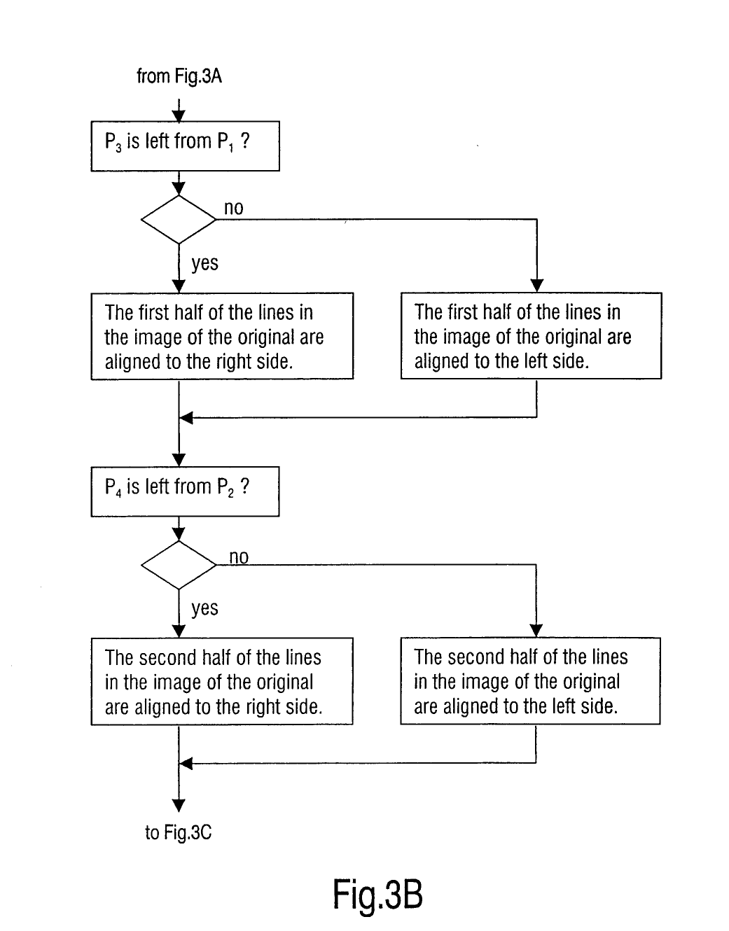

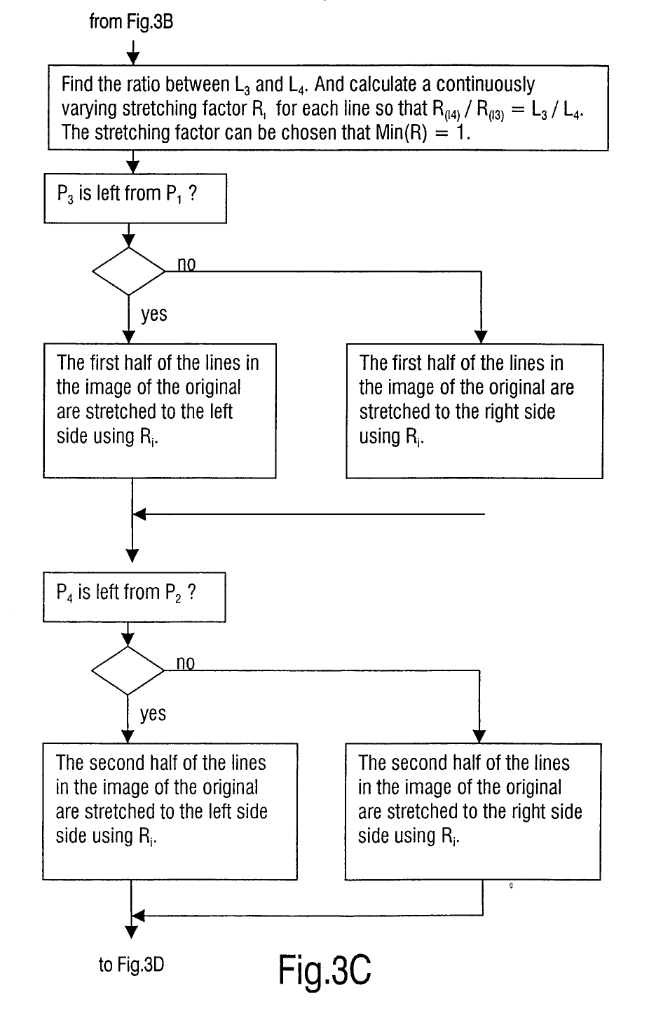

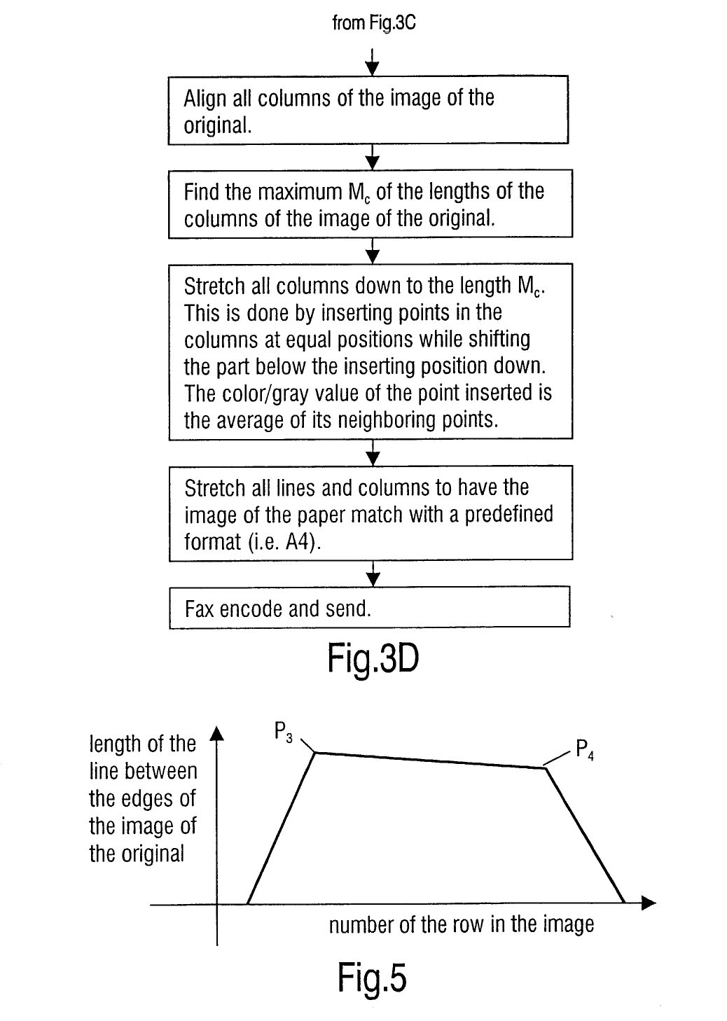

FIGS. 3A, 3B, 3C and 3D respectively show the algorithm of FIG. 2 in greater detail;

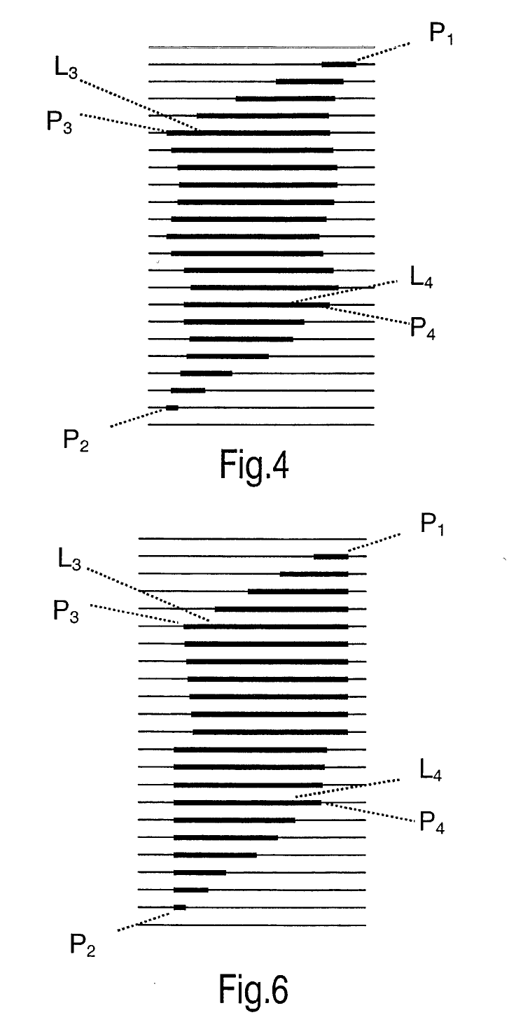

FIG. 4 shows by way of example a distorted scanned image (represented by bold lines), wherein characteristic points P₁-P₄ and lengths L₃-L₄ of lines of the image are identified;

FIG. 5 shows a graph of the respective lengths of the lines in the scanned image against the number of the rows in the scanned image to find the characteristic points P₃ and P₄;

FIG. 6 shows the image taken (represented by bold lines) after alignment of the edges of the scanned image according to a first aspect of the method according to the invention;

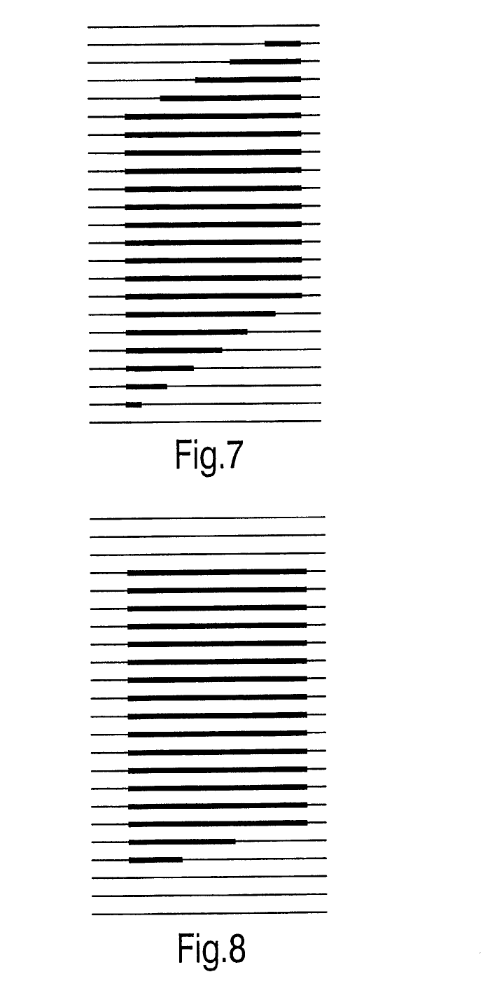

FIG. 7 shows the image taken (represented by bold lines) after stretching of the lines of the scanned image according to a second aspect of the method according to the invention;

FIG. 8 shows the image taken (represented by bold lines) after alignment of the columns of the image according to a third aspect of the method according to the invention;

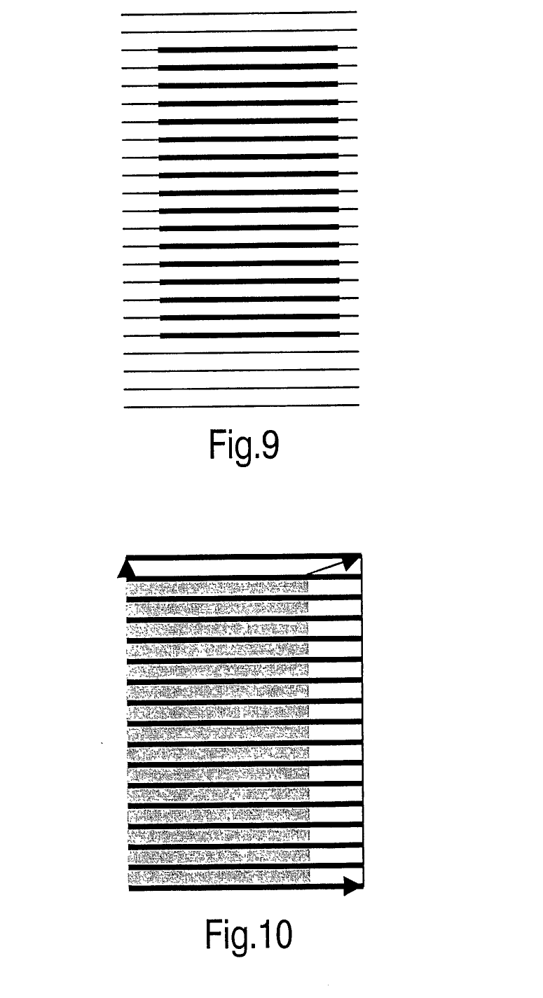

FIG. 9 shows the image taken (represented by bold lines) after stretching of the columns of the image according to a fourth aspect of the method according to the invention; and

FIG. 10 shows the image taken (represented by bold lines) after stretching of the image to a desired page format according to a fifth aspect of the method according to the invention.

FIG. 1 shows a possible embodiment of an image device 1 which may be included in a data processing device D, such as an organizer or some type of communication device, for example a telephone, mobile telephone or the like. The image device 1 comprises an image means 2 for taking an initial image, referred to by I, including graphics, text, characters, pictures or the like. The image means are camera means 2, such as a video camera, a line scan camera for example a CCD camera, an image camera for example a CMOS image camera, or even a combination of one or more of such cameras. Images recorded by the camera means 2 are stored in some memory 3, which usually is associated with the camera means. The image device 1 further comprises an image correcting means 4 which usually is some kind of properly programmed image processor coupled to the camera means 2 for correcting image errors of the image taken. The image I is reproduced on a flat background such as a piece of paper P which has a predetermined format, such as an A4 format. The camera means 2 take the image and record the image I on paper P and thereto the means 2 are usually held possibly hand held near the central line C and above the image I to be taken. Starting from a virtually flat piece of paper this inevitably leads to perspective distortions in the image stored in the memory 3 as taken image data. These distortions are corrected by the image correcting means 4 by effecting image sizing on the image taken. The sizing in turn is effected by aligning (hereafter also called shifting) and stretching of image rows and image columns containing pixels whereof the image taken is built of. The sizing operation is implemented in an image processing algorithm in the means 4. Thereto the edges and corners of the original image are identified, where after the edges and corners of the image taken are transformed until these are conform with those of the original image. This way image distortions are corrected such as perspective, angle and staggering distortions.

The algorithm of the image processing method for sizing or straightening the image taken is provided by FIG. 2. After identifying the edges and corners as the border of the paper containing the image to be taken, each line and column is being stretched and aligned (shifted) generally with a continuous function, so that opposing edges of the corrected image will be parallel. Finally the resulting rectangle of the corrected image is being stretched to the desired format, where after the corrected and formatted image may be fax encoded and possibly transmitted by the communication device D.

A possible embodiment of the image processing method for correcting the image taken will hereafter be explained in greater detail. Thereto FIG. 4 shows by way of example a distorted image taken whose corresponding image pixel data is stored in the memory 3. The part of each pixel row of the image taken is marked bold in the figures concerned, whereas the background is drawn in normal lines. Characteristic points in the image taken are indicated P₁,P₂,P₃ and P₄ and characteristic lengths are indicated L₃ and L₄. P₁ and P₂ are corner points of the image taken and can be identified by finding the upper right and lower left border points respectively, marking the contrast difference between the end of the bold image line and the normal background. Depending on the position of the camera 3 relative to the center line C of the original image I, P₁ may be present upper right and P₂ may be present lower left. The points P₃ and P₄ can be found there where the respective lengths of the horizontal lines present in the middle of the image taken start to decrease rather drastically towards the top and bottom respectively of that image. This in turn is illustrated in FIG. 5 showing a graph of the lengths of the horizontal lines in the image taken against the number of the rows in the image. The discontinuity points in the graph of FIG. 5 represent the characteristic points P₃ and P₄. The lengths of the lines associated with P₃ and P₄ are indicated L₃ and L₄.

Thus according to FIG. 3A after appropriate pre-processing, such as initialization and contrast enhancement, if necessary, the paper border identification mentioned above and the finding of P₁-P₄ a removing of staggering of the image shown in FIG. 4 can start in dependence on whether P₃ is left from P₁ and P₄ is left from P₂. Such a staggering may arise from moving or shaking of the camera means during the taking of the image. Now if P₃ is left from P₁ then the first half of the lines in the image of FIG. 4 are aligned to the right side, else they are aligned to the left side. Similarly if P₄ is left from P₂ then the second half of the image lines are aligned to the right side, else to the left side.

The results of the aligning of the image lines is shown in FIG. 6. The image line stretching steps are detailed in FIG. 3C. At first an appropriate image line length dependent stretching factor Rᵢ is determined. The stretching is done by inserting additional pixel points into the line at equal distances. These additional points have a color or gray value—in black and white—which is the average of the respective colors of the neighboring points. Stretching factor Rᵢ for line number i is given by: R₁₄/R₁₃=L₃/L₄ (where I3 is the number of the line having length L₃ associated with point P₃ and I4 is the number of the line having length L₄ associated with point P₄) whereby the stretching is again dependent on the points positions. If P₃ is left from P₁ then the first half of the lines in the image of FIG. 6 are stretched to the left side, else they are aligned to the right side. Similarly if P₄ is left from P₂ then the second half of the image lines are stretched to the left side, else at the right side.

The results of the stretching of the lines is shown in FIG. 7. Now according to FIG. 3D all columns of the image are aligned to the top of the image and the results thereof is shown in FIG. 8. After finding the maximum, indicated M_{c}, of the lengths of the columns of the image all columns are stretched down to this maximum length. This is done by inserting additional pixel points into the columns at equal positions, while shifting the part below the insertion position down. These additional points have a color or gray value—in black and white—which is the average of the respective colors of the neighboring points. The result of the column stretching shows FIG. 9. Finally all lines and all columns of the image are then stretched—see FIG. 10—to have the thus corrected image size match the size—for example A4—of the paper P, where after at wish the corrected image may be fax encoded and sent out by the device D.

In a possible modification of the method explained above the stretching factor Rᵢ may be chosen such that the image concerned is immediately stretched to the width of the desired format. This saves processing time in the last but one step of FIG. 3C. In a further modification the algorithm can operate in a way wherein an immediate horizontal and vertical stretching is performed to horizontal and vertical lengths respectively. The final rectangle resulting then has the desired format and does not need any further stretching. If the image resolution is higher than the resolution of the resulting image (which may for example be fax encoded) the sizing steps may only include stretching and contraction.

Whilst the above has been described with reference to essentially preferred embodiments and best possible modes it will be understood that these embodiments are by no means to be construed as limiting examples of the device and method concerned, because various modifications, features and combination of features falling within the scope of the appended claims are now within reach of the skilled person. It should be clear also that the above explained method steps may be implemented in software, but also in hardware units, such as in dedicated chips and circuitry. In particular one or more camera means may be used, such that during the taking or scanning of an image by the devices concerned the speed and the angle of the movement relative to the image center line can be registered for additional correction purposes in order to improve the image quality even further. If for example a CMOS 1030×1286 pixel array is used for taking the image then digital photography quality can be achieved. Naturally electronic scans instead of manual scans will improve the image quality also. In addition a video chip or so called flash reduces the exposure time and therewith the negative staggering effects of unwanted hand movements while taking the image. The above proposed correction holds in particular if the perspective distortions are relatively small.

1. An image device (1), comprising an image means (2) for taking an initial image (I) including graphics and/or text, and an image correcting means (4) coupled to the image means (2) for correcting the image taken, characterized in that the image means (2) are camera means (2), and that the image correcting means (4) are arranged for performing perspective corrections by effecting image sizing on the image taken.

2. The image device (1) according to claim 1, characterized in that the image correcting means (4) are additionally arranged for performing rotation and/or staggering corrections.

3. The image device (1) according to claim 1 or 2, characterized in that the image correcting means (4) are arranged as alignment means for effecting left and/or right edge alignment along respective edges of the image taken.

4. The image device (1) according to one of the claims 1-3, characterized in that the image correcting means (4) are arranged as image contracting and/or image stretching means (4), in particular image line and/or image column contracting and stretching means respectively.

5. A data processing device (D), such as an organizer or a communication device, for example a telephone, in particular a mobile telephone, which data processing device (D) is provided with an image device according to one of the claims 1-4.

6. A method for processing an image taken, the image comprising image lines and image columns, which method is characterized by one or more of the following steps of:
aligning the image lines;
sizing the image lines;
aligning the image columns;
sizing the image columns;
sizing the image lines and image columns to form a desired processed image format.

7. The method according to claim 6, characterized in that the sizing is stretching and/or contracting of the image taken.

8. The method according to claim 7, characterized in that the amount of stretching of the image lines and/or image columns is a linear function of the length and position of a first and a last complete image line and/or image column respectively.

9. An image, including graphics data and/or text data processed according to the method according to one of the claims 6-8, in particular by means of the device (1; D) according to one of the claims 1-5.
